(19) United States
(12) Patent Application Publication
(10) Pub. No.: US 2007/0005612 A1
(43) Pub. Date: Jan. 4, 2007

(54) Methods and systems for optimizing searches within relational databases having hierarchical data

(75) Inventors: Sweefen Goh, Hartsdale, NY (US); George A. Mihaila, Yorktown Heights, NY (US); Maroun Touma, Redding, CT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/168,868

(22) Filed: Jun. 29, 2005

(51) Int. Cl. G06F 7/00

(52) U.S. Cl. 707/100

(57) ABSTRACT

A method and system for preparing a relational database for searching includes determining a hierarchy of data within the relational database, and storing a hierarchical label for at least one record of data within the relational database that corresponds to the hierarchy of the data.

### BACKGROUND OF THE INVENTION

1. Field of the Invention

The present invention generally relates to database query techniques and more specifically to methods and systems for optimizing searches within relational databases having hierarchical data.

2. Description of the Related Art

Database systems are generally used to store and manipulate data. Relational database systems are a popular type of database system due to the many widely known benefits to storing and manipulating data using a relational database structure.

Relational databases are generally maintained by software systems that are referred to as Relational Database Management Systems (RDBMS). Relational Database Management Systems are, generally, able to be distributed among two or more computer nodes that are able to be physically and even geographically separated.

Therefore, an enterprise, which takes advantage of a relational database structure, may distribute data among multiple Relational Database Management Systems that are hosted on different computers. Retrieval of a complete set of data for a particular request within such enterprises then requires access to the multiple Relational Database Management Systems.

Frequently, these relational database structures include data that is hierarchical. For example, a relational database structure may be used to generate a bill of materials.

FIG. 1 illustrates, for example, the hierarchical relationships of modules, assemblies and parts for a car 100. Each component of the hierarchical structure is provided with an identifier 102, which is unique for each component, and these identifiers 102 have no relationship to each other. In this instance, the highest level in the hierarchical structure is the car 100 which has an identifier of“1.” The car 100 is known as a “module” or as an “assembly” because the car 100 includes “child” assemblies such as powertrain 104, interior 106, body 108, etc.

FIG. 1 illustrates that the body 108 also includes a door assembly/module 110, which, in turn, includes a window assembly/module 112, which, in turn, includes a glass assembly/module 114 and a drive assembly/module 116. The drive module 116 includes parts such as a switch 118, a motor 120, a belt 122, and a bracket 124. The switch 118, motor 120, belt 122, and the bracket 124 are at the atomic level because those components form the lowest level of the structure that is illustrated by FIG. 1.

FIG. 2 illustrates two exemplary tables for a conventional relational database. FIG. 2 includes an items definition table 200 and a parts list table 202. The items definition table 200 in this instance contains information about each item in isolation. The items definition table 200 includes an “itemID” 204 which is a key to the data in the items definition table 200 to access the other information that is related to a particular item in the items definition table 200.

The parts list table 202 has a “partID” that is the key to the parts list table 202. The parts list table 202 is useful for determining, for a particular part, to which assembly the part belongs, to which module the part belongs, etc.

These two tables, 200 and 202, are related to each other because they both include a similarly formatted key component. In this case, the “itemID” 204 component in the items definition table 200 relies upon the same structure as the “partID” 206 component in the parts list table 202. The “itemID” 204 and the “partID” 206 are both keys for the data stored in the tables 200 and 202.

FIG. 3 illustrates a particular instance for an items definition table 300 and a parts list table 302 in accordance with the format illustrated by FIG. 2 and in accordance with a portion of the hierarchical structure that is illustrated by FIG. 1.

In particular, the items definition table 300 and the parts list table 302 are populated with entries which include part identifiers 102 for the window module 112, the drive assembly 116, the switch 118, the motor 120, the belt 122, and the bracket 124 from FIG. 1. These tables are related to each other with the part ID (also known as item ID) numbers 102.

Conventional methods and systems typically involve the execution of either a sequence of structured query language (SQL) statements or the execution of a recursive structured query language statement.

In the first conventional case, multiple structured query language statements must be submitted to the Relational Database Management System. The first statement retrieves the part number of the top-level assemblies. Then, for each assembly that is retrieved, another structured query language statement must be submitted to retrieve all the constituent parts in that assembly, and so on, until all the atomic parts for all assemblies have been retrieved. Thus, this conventional method requires submitting a large number of requests to the database system and is, therefore, inefficient.

The second conventional solution relies upon a recursive structured query language statement to retrieve all the parts. However, recursive structured query language statements are known to be slow to execute because they need to examine the underlying table(s) multiple times, until a fixpoint (the transitive closure of the parent-child relationship) is computed. In other words, the recursive structured query language statement continues to query the databases until the results no longer change (i.e., there are no more parts to retrieve).

FIG. 4 illustrates a conventional recursive query in a structured query language. The recursive query includes a “WITH” clause that defines a temporary table that is called “RPL” and includes “assembly ID,” “ItemID,” “quantity,” etc., and also includes an indicator “1” that indicates a level of one.

Next, this conventional query includes a definition for this table “RPL” (within the parenthesis). This definition indicates that a join is required between a parts list and an items definition table where a union is formed by recursively assembling all the parts and the sub-parts from the tables. Lastly, the query selects certain elements from the temporary “RPL” table, such as assemblyID, ItemID, Quantity, ITEMDescription, and level.

The recursive portion of this query appears after “UNION ALL” and after the “SELECT CHILD” statements that states “FROM RPL AS PARENT, PartsList, AS CHILD.” This statement recursively uses the “RPL” table that is being constructed to obtain all of the parts within all assemblies. Thus, this query performs an iterative process to obtain all of the assemblies, and then obtains all of the children of each of the assemblies until no more children exist.

It is desirable to retrieve a properly ordered result from the query. In other words, it is desirable to retrieve all of the parts in the correct order (e.g., from general to specific). For example, an assembly should first be retrieved, followed by a sub-assembly (or part) within that assembly, followed by a sub-sub-assembly (or part) within that sub-assembly. This process should be repeated until the atomic level is reached and all of the sub-assemblies (or parts) are obtained, then the next sub-assembly is listed, then all of the sub-sub-assemblies for that next sub-assembly, and so on.

However, many conventional relational database structures do not retrieve a properly ordered result from the query, or if so, do not do so quickly and efficiently.

In addition to the above-problems, most relational database structures do not match the hierarchical structure of the data that is stored in the relational database. Therefore, it has not been possible to easily and quickly obtain ordered hierarchical output from a relational database.

### SUMMARY OF THE INVENTION

In view of the foregoing and other exemplary problems, drawbacks, and disadvantages of the conventional methods and systems, an exemplary feature of the present invention is to provide a method and structure in which the computation of a value from data (e.g., a manufacturing bill of materials) in a relational database is optimized.

In a first exemplary aspect of the present invention, a method for preparing a relational database for searching includes determining a hierarchy of data within said relational database, and storing hierarchical labels for each record of data within the relational database that corresponds to the hierarchy of the data.

In a second exemplary aspect of the present invention, a method of obtaining an ordered list of records from a relational database includes performing a single pass query upon a hierarchical set of data, each record of the hierarchical set of data having a label indicating a hierarchy of the data, and outputting an ordered list of records which are ordered in accordance with the hierarchy of the data.

In a third exemplary aspect of the present invention, a method for deploying computing infrastructure for preparing a relational database for searching, includes integrating computer-readable code into a computing system. The computer-readable code includes instructions for determining a hierarchy of data within the relational database, and instructions for storing hierarchical labels for each record of data within the relational database that corresponds to the hierarchy of the data.

In a fourth exemplary aspect of the present invention, a signal bearing medium containing a set of instructions executable by a digital data processing unit for preparing a relational database for searching, the set of instructions includes a determining routine for determining a hierarchy of data within the relational database, and a storing routine for storing hierarchical labels for each record of data within the relational database that corresponds to the hierarchy of the data.

In an exemplary, non-limiting embodiment, the present invention describes a method for optimizing the computation of a manufacturing bill of materials from data in a relational database. As would be known to one of ordinary skill in the art taking the present application as a whole, the invention certainly is not limited to this application, but can be applied to any computation from data in a relational database.

An exemplary embodiment of the present invention applies hierarchical labels to data that correspond to the hierarchy of the data within a relational database.

In an exemplary embodiment of the present invention, the parts/subparts relationships are examined, while data regarding these parts/subparts are loaded, and a hierarchical label is then applied to each part/subpart.

Providing the hierarchical labels in accordance with an exemplary embodiment of the present invention then allows a structured query to obtain all of the desired results in a single pass. In this manner, the present invention is significantly faster at providing the desired results in comparison with conventional methods and systems.

An exemplary embodiment of the present invention provides a method and system for optimizing the computation of a manufacturing bill of materials from data in a relational database.

In one exemplary embodiment of the present invention each part involved in an assembly is labeled using a hierarchical scheme that may be similar to the one used in the Dewey decimal library classification system. For example, the top-level assemblies may be labeled with a number (e.g. “1”, “2”), the second level assemblies may be labeled with a label obtained by appending the label of the parent with a dot and a sequence number (e.g. “1.1”, “1.2”, “1.3”, “2.1”), and so on for the parts at subsequent levels. Other hierarchical schemes may also be used such as an alphabetical, an alpha-numeric, etc.

In an exemplary embodiment of the present invention, this labeling activity may be performed as a pre-processing step. Therefore, at the time when a bill of materials needs to be generated, a single, non-recursive structured query language (SQL) query that executes a single pass on a table will retrieve all the parts.

Another advantage of an exemplary embodiment of the present invention is the ability to retrieve all the parts in the correct order (as described above). This is easily accomplished because the lexicographic order of the hierarchical labels may be the same as a depth-first traversal order of the hierarchical structure.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 depicts an exemplary hierarchical structure describing the components of a car;

FIG. 2 illustrates a relational schema for a relational database that stores information about various modules, assemblies and parts used in a car;

FIG. 3 shows a part of the data content of the relational tables 300 and 302 presented in FIG. 2 corresponding to the structure in FIG. 1;

FIG. 4 shows a recursive structured query language query 400 that can be used to compute a bill of materials for the structure of the tables in FIG. 3;

FIG. 5 shows an example of hierarchical labeling for the internal structure of a top-level module in accordance with an exemplary embodiment of the present invention;

FIG. 6 shows an Extended PartsList Table 600 that includes a portion of the data content of the PartList table 302, but which has been augmented with a column for hierarchical labels module in accordance with an exemplary embodiment of the present invention;

FIG. 7 illustrates an exemplary structured query language query that obtains a bill of materials in a single pass over the Extended PartsList Table 600 of FIG. 6 and the ItemsDefinition table 300 of FIG. 3;

FIG. 8A illustrates one exemplary embodiment of a flowchart for a control routine that embodies one exemplary embodiment of a labeling algorithm module in accordance with an exemplary embodiment of the present invention;

FIG. 8B illustrates an exemplary system for obtaining an ordered list from hierarchical data within a relational database management system in accordance with an exemplary embodiment of the present invention;

FIG. 9 illustrates an exemplary hardware/information handling system 900 for incorporating the present invention therein; and

FIG. 10 illustrates a signal bearing medium 1000 (e.g., storage medium) for storing steps of a program of a method according to the present invention.

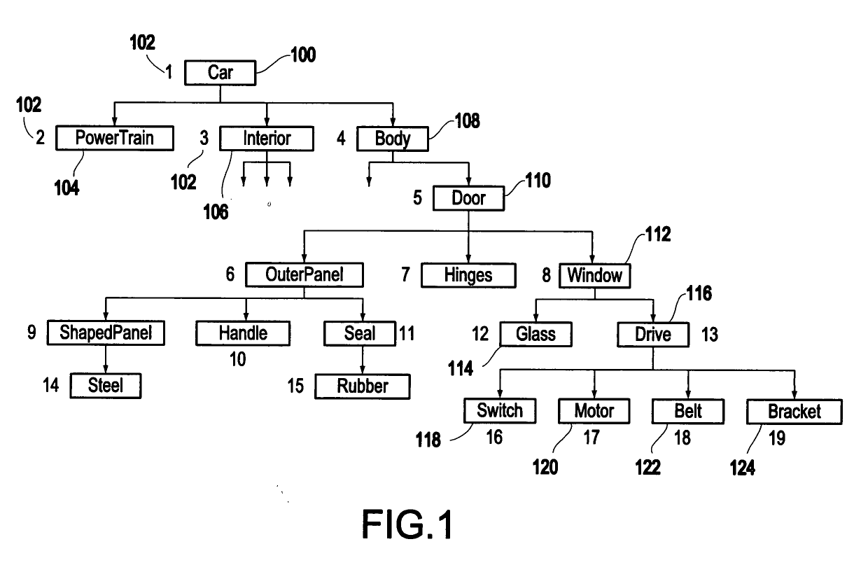

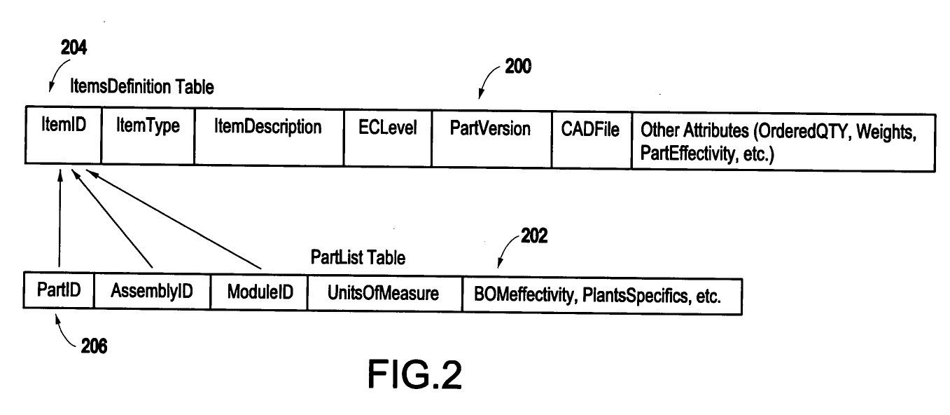

### DETAILED DESCRIPTION OF EXEMPLARY EMBODIMENTS OF THE INVENTION

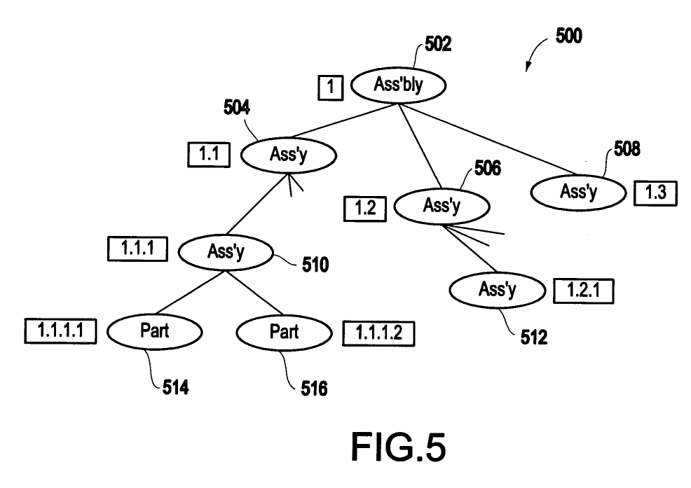

Referring now to the drawings, and more particularly to FIGS. 5-10, there are shown exemplary embodiments of the method and structures of the present invention.

FIG. 5 illustrates one concept of hierarchical labeling. Specifically, FIG. 5 illustrates a hierarchical tree diagram 500 having a top-level assembly node 502, second-level children nodes 504, 506, and 508, third-level children nodes 510 and 512, and fourth-level children nodes 514 and 516. Nodes 512, 514, and 516 happen to be at the atomic (part) level of the hierarchical tree diagram 500.

A hierarchical labeling scheme in accordance with an exemplary embodiment of the present invention has been applied to the hierarchical tree diagram 500 of FIG. 5. In this regard, the hierarchical labeling scheme applies a unique number as a label for each of the top-level assemblies and also applies a unique number for each child of each top-level assembly. The exemplary labeling scheme then appends a dot and a number that is unique to each child to the parent label to provide a label for all of the children of the corresponding parent assembly.

In the example illustrated by FIG. 5, the hierarchical labeling scheme in accordance with an exemplary embodiment of the present invention assigns a unique number for a label of “1” to the top-level assembly node 502. The scheme also assigns a unique number to each child node 504, 506, and 508. The scheme then appends a dot (e.g., “.”) and the corresponding unique number to the parent label to arrive at a label for each child node. For example, child node 504 has a label that includes the parent label “1” from parent node 502, the scheme then appends a dot, and the unique number “1” to arrive at a label of “1.1” for the child node 504.

Similarly, child nodes 506 and 508 have been assigned labels “1.2” and “1.3,” respectively. The exemplary scheme continues to apply labels to all nodes within the hierarchical tree structure 500.

A hierarchical labeling scheme in accordance with an exemplary embodiment of the present invention may be applied as part of a pre-processing step which prepares at least one of the databases within a relational database structure in order to prepare the relational database for more efficient searching and retrieval.

While an exemplary embodiment of the present invention may rely upon a recursive query in order to apply the hierarchical labels to the hierarchical data, performing the label application step as a pre-processing step ensures that the step only has to be accomplished once. Therefore, the labeling does not have to be performed every time a query is received by the relational database system. For example, an exemplary embodiment of the present invention may be applied during a data loading process, rather than during a query process.

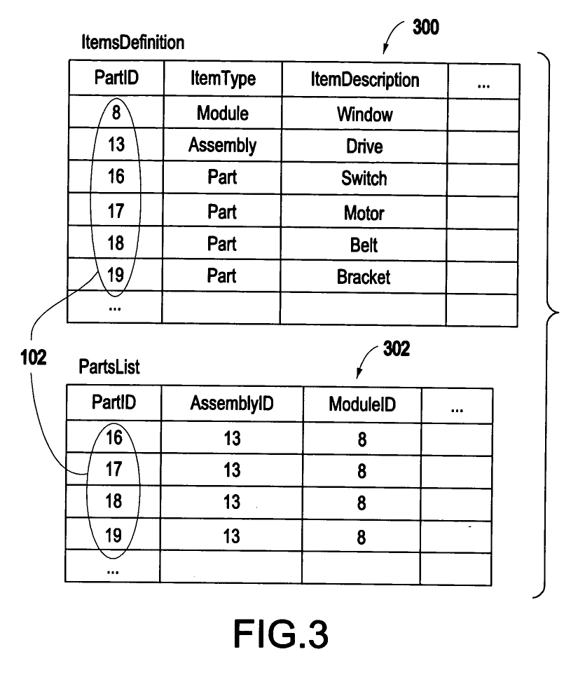

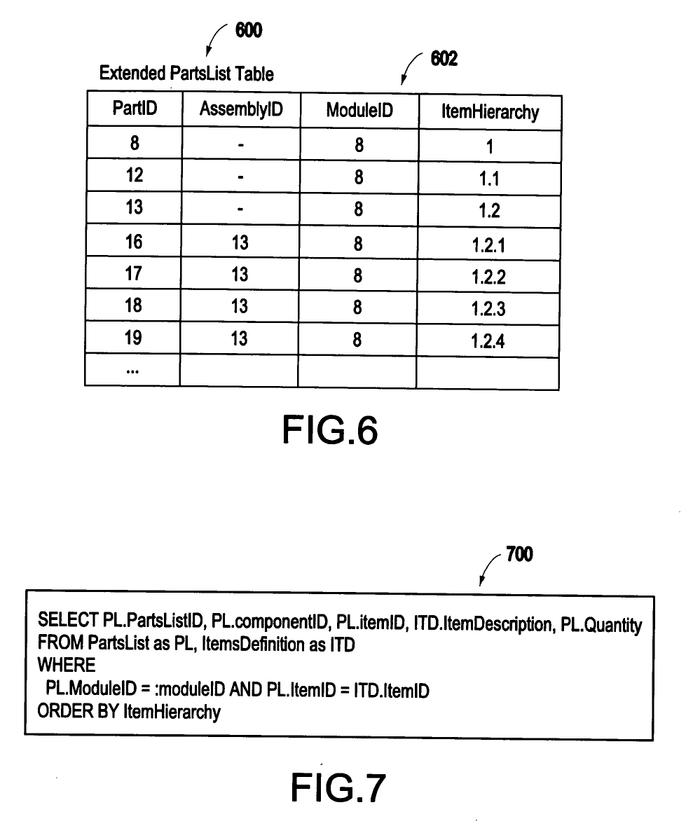

An example of a database 600 upon which an exemplary embodiment of the present invention has been applied is illustrated by FIG. 6. FIG. 6 shows an “Extended PartsList Table” which is substantially similar to the “PartsList” table 302 of FIG. 3, but which has been extended by adding the hierarchical labels 602 in accordance with an exemplary embodiment of the present invention. These hierarchical labels 602 are illustrated in the last column of the “Extended PartsList Table” 600 under the column heading of “ItemHierarchy.”

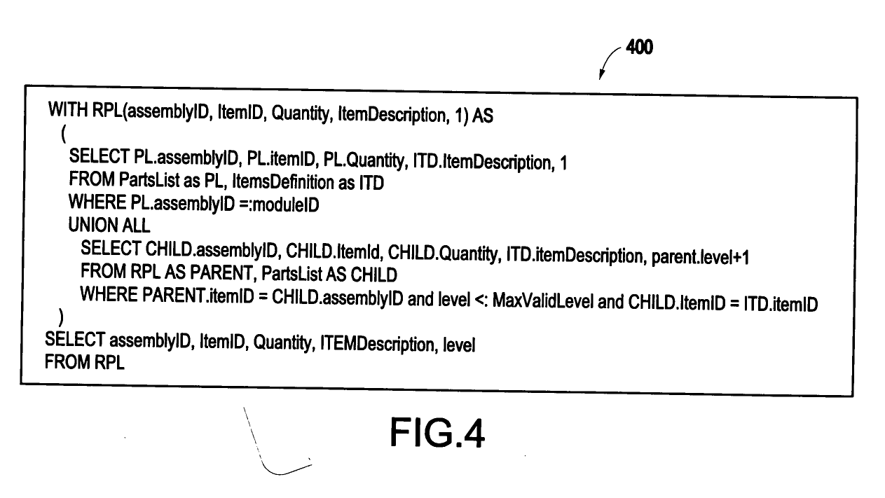

FIG. 7 illustrates an exemplary structured query language query 700 in accordance with the present invention. As may be easily seen, the query 700 is much simpler than the conventional type of query 400 illustrated in FIG. 4. The increased simplicity of the query 700 over the query 400 means that the query 700 operates much more efficiently than the query 400.

Additionally, the query 700 only needs to perform a single-pass of the databases within the relational database structure to obtain the desired results. The query 700 is able to obtain these advantages because the query 700 is able to rely upon the hierarchical labels that are ordered by “ItemHierarchy”. That is, the hierarchical labels greatly simplify the search for results in the relational database by only requiring a single-pass.

In addition to providing the benefits, with respect to obtaining a list of all children of any particular parent node in a hierarchical tree, the hierarchical labels applied by an exemplary embodiment of the present invention also enables the determination of all the parents that correspond with any particular child node and also the level of depth for any particular node with the hierarchical structure of the data.

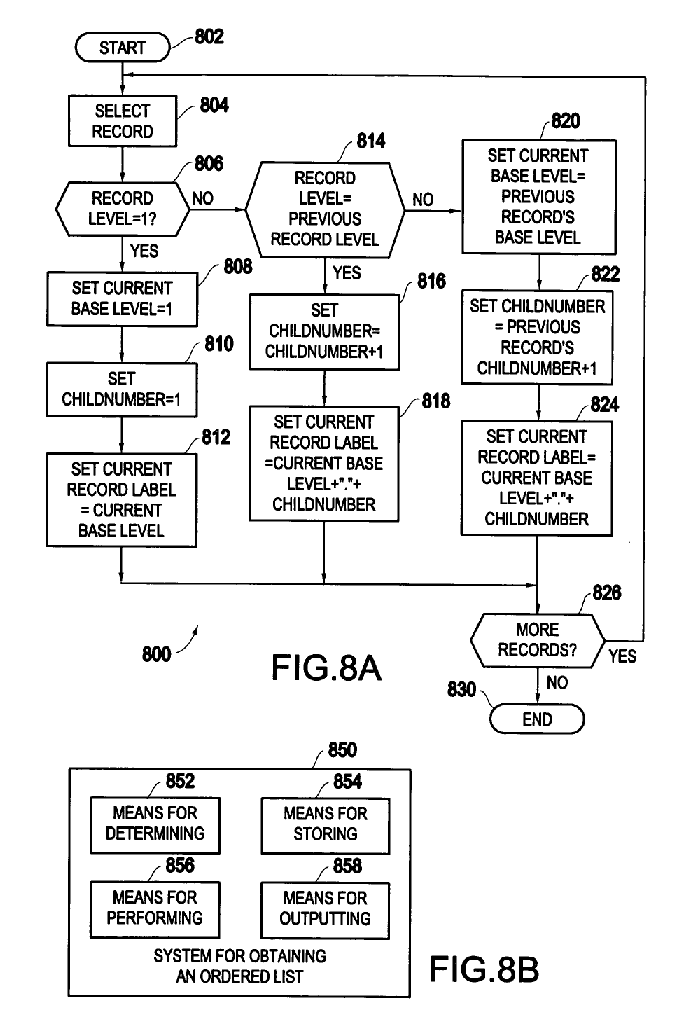

FIG. 8A illustrates a flowchart 800 for an exemplary control routine in accordance with the present invention.

The control routine starts at step 802 and continues to step 804 where the control routine selects a record from within the hierarchical data structure.

In step 806, the control routine determines whether the current record is at a level of “1.” If, in step 806, the control routine determines that the current record is at a level of “1,” then in step 808, the control routine sets the current base level equal to “1,” continues to step 810, where the control routine sets the “childNumber” equal to “1,” and continues to step 812 where the current record label is assigned to equal the current base level. The control routine then continues to step 826.

If, however, in step 806, the control routine determines that the record level does not equal “1,” then in step 814, the control routine determines whether the current record level equals the previous record level. If, in step 814, the control routine determines that the current record level does equal the previous record level, then the control routine continues to step 816.

In step 816, the control routine increments the “childNumber” variable by one. In step 818, the control routine sets the current record label equal to the current base level plus a dot (“.”) and the “childNumber.”

If, however, in step 814, the control routine determines that the current record level does not equal the previous record level, then the control routine continues to step 820.

In step 820, the control routine sets the current base level equal to the previous record's base level. The control routine then continues to step 822 where the control routine sets “childNumber” equal to the previous record's “childNumber” plus one (e.g., increments the “ChildNumber” value). The control routine then continues to step 824 where the control routine sets the current record label equal to the current base level plus a dot (“.”) and the “childNumber.”

The control routine then continues to step 826 where the control routine determines if there are any more records in the relational database. If, in step 826, the control routine determines that there are more records, then the control routine returns to step 804. If, however, in step 826, the control routine determines that there are no more records in the relational database, then the control routine continues to step 830 where the control routine ends.

In this manner, this exemplary embodiment of the present invention applies a hierarchical labeling scheme to hierarchical data within a relational database.

An exemplary embodiment of the present invention may perform the above-described routine upon any number of databases within a relational database management system. Preferably, the databases will contain tables with hierarchical information about parts.

In an exemplary embodiment of the present invention, the labels for each record may be stored in, for example, a newly created column in an existing table within at least one of the databases within the relational database management system.

Alternatively, another exemplary embodiment may store the labels for each record in a new table. For example, the structured query language query detailed below creates a new table called “ItemHierarchy” that has two columns. The first column is labeled “itemID” and the second column is labeled “itemHierarchy.”

In this alternative embodiment, to generate the bill of materials, the query joins existing tables with the newly created table.
SELECT PL.PartsListID, PL.componentID, PL.itemID, ITD.ItemDescription, PL.Quantity
FROM PartsList as PL, ItemsDefinition as ITD, ItemHierarchy as IH
WHERE
   PL.ModuleID=moduleID AND PL.ItemID=ITD.ItemID AND ITD.ItemID=IH.ItemID
ORDER BY IH.ItemHierarchy

In yet another exemplary embodiment of the present invention, the labels may be appended as a new column into an existing table. Appending these labels may be accomplished by, for example, the use of an “UPDATE” statement such as:
UPDATE PartsList SET ItemHierarchy=:itemHierarchy
WHERE ItemID=:itemID

In contrast, in an exemplary embodiment of the present invention where the hierarchical labels are stored in a separate table, a query may store these labels using an “INSERT” statement, such as, for example:
INSERT INTO ItemHierarchy (itemID, itemHierarchy)
VALUES (:itemID, :itemHierarchy).

In both of the above statements, the names preceded by colon (:itemID and :itemHierarchy) may represent program variables which are bound to those positions in the statement (using an embedded structured query language notation).

FIG. 8B illustrates an exemplary system 850 for obtaining an ordered list from hierarchical data within a relational database management system in accordance with an exemplary embodiment of the present invention.

The system 850 includes means (e.g., a processor or the like) for determining 852 the hierarchy of the hierarchical data within the relational database management system, means (e.g., memory such as RAM, ROM, or the like) for storing 854 the hierarchical labels for each record of data within the relational database that corresponds to the hierarchy of the hierarchical data, means (e.g., a processor or the like) for performing 856 a single pass query upon the data having the hierarchical labels, and means (e.g., a display, a printer, or the like) for outputting 858 an ordered list of records which are ordered in accordance with the hierarchy of the data.

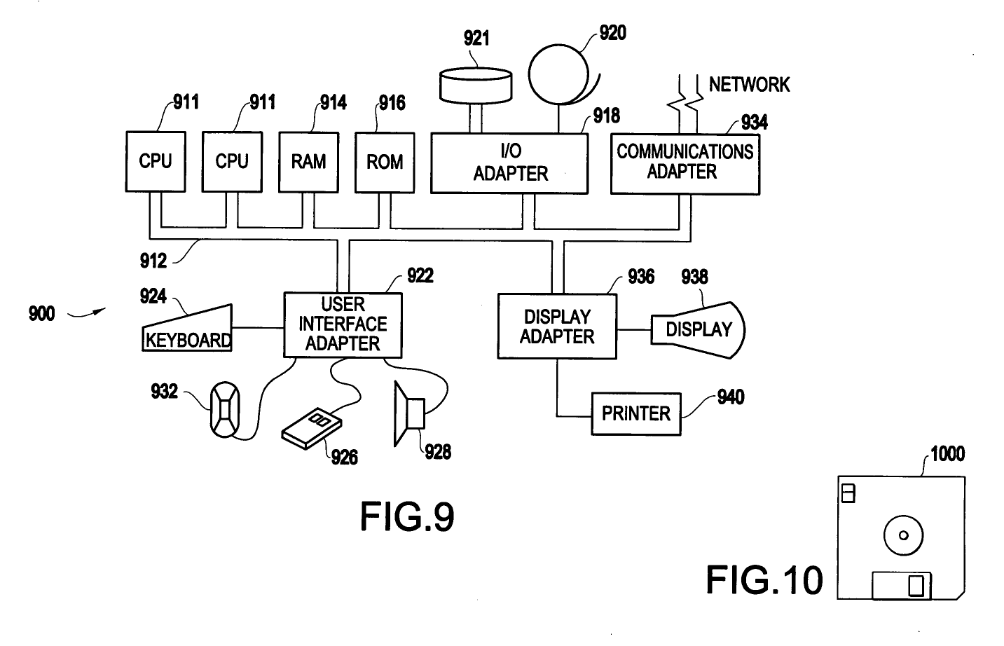

FIG. 9 illustrates a typical hardware configuration of an information handling/computer system for use with the invention (e.g., implementing the system 850) and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 920 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 940.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method for preparing a relational database for searching, the method comprising:
determining a hierarchy of data within said relational database; and
storing hierarchical labels for at least one record of data within said relational database that corresponds to said hierarchy of said data.

2. The method of claim 1, wherein said storing comprises:
inserting said hierarchical labels into a pre-existing database within said relational database.

3. The method of claim 1, wherein said storing comprises:
creating a new database within said relational database; and
inserting said hierarchical labels into said new database.

4. The method of claim 1, wherein at least one of said hierarchical labels comprises:
a sequential number from a parent node; and
a sequential number for a child node.

5. The method of claim 4, wherein said at least one of said hierarchical labels further comprises a dot between said sequential number for said parent node and said sequential number for said child node.

6. The method of claim 1, wherein said data comprises data regarding at least one of an assembly and subassembly for an article of manufacture.

7. The method of claim 1, further comprising performing a single pass query upon said data having said hierarchical labels.

8. The method of claim 7, further comprising outputting an ordered list of records which are ordered in accordance with said hierarchy of said data.

9. A method of obtaining an ordered list of records from a relational database, the method comprising:
performing a single pass query upon a hierarchical set of data, at least one record of said hierarchical set of data having a label indicating a hierarchy of said data; and
outputting an ordered list of records which are ordered in accordance with said hierarchy of said data.

10. The method of claim 9, wherein said hierarchical data comprises data regarding at least one of an assembly and a subassembly for an article of manufacture.

11. The method of claim 9, wherein said ordered list of records comprises a bill of materials for said article of manufacture.

12. The method of claim 9, wherein a structure of a relational database management system performing said method does not match the hierarchical structure of said data.

13. A method for deploying computing infrastructure for preparing a relational database for searching, comprising integrating computer-readable code into a computing system, the computer-readable code comprising:
instructions for determining a hierarchy of data within said relational database; and
instructions for storing hierarchical labels for at least one record of data within said relational database that corresponds to said hierarchy of said data.

14. The method of claim 13, wherein said computer-readable code further comprises:
instructions for performing a single pass query upon said data having said hierarchical labels.

15. The method of claim 14, wherein said computer-readable code further comprises:
instructions for outputting an ordered list of records which are ordered in accordance with said hierarchy of said data.

16. The method of claim 15, wherein said data comprises data regarding at least one of an assembly and a subassembly for an article of manufacture,
wherein said ordered list of records comprises a bill of materials for said article of manufacture, and
wherein a structure of a relational database management system managing said data does not match the hierarchical structure of said data.

17. A signal bearing medium containing a set of instructions executable by a digital data processing unit for preparing a relational database for searching, the set of instructions comprising:
a determining routine for determining a hierarchy of data within said relational database; and
a storing routine for storing hierarchical labels for each record of data within said relational database that corresponds to said hierarchy of said data.

18. The signal bearing medium of claim 17, further comprising a performing routine for performing a single pass query upon said data having said hierarchical labels.

19. The signal bearing medium of claim 18, further comprising an outputting routine for outputting an ordered list of records which are ordered in accordance with said hierarchy of said data.

20. The signal bearing medium of claim 19, wherein said data comprises data regarding at least one of an assembly and a subassembly for an article of manufacture, and wherein said ordered list of records comprises a bill of materials for said article of manufacture.
